(19) United States
(12) Patent Application Publication
(10) Pub. No.: US 2013/0054417 A1
(43) Pub. Date: Feb. 28, 2013

(54) METHODS AND SYSTEMS AGGREGATING MICROPAYMENTS IN A MOBILE DEVICE

(71) Applicants: Jeremy R. O'Donoghue, Farnborough (GB); John Hillan, Farnborough (GB)

(72) Inventors: Jeremy R. O'Donoghue, Farnborough (GB); John Hillan, Farnborough (GB)

(73) Assignee: QUALCOMM INCORPORATED, San Diego, CA (US)

(21) Appl. No.: 13/281,950

(22) Filed: Oct. 26, 2011

Related U.S. Application Data
(60) Provisional application No. 61/529,012, filed on Aug. 30, 2011.

(51) Int. Cl. G06Q 30/06

(52) U.S. Cl. 705/26.43; 705/26.41; 705/26.1

(57) ABSTRACT

Various aspects include methods and devices for aggregating a number of micro-payment transactions within a secure memory of a purchaser's computing device to enable completion of micropayment electronic commerce transactions with reduce the number of fund transfers and verification messages. Transactions in which a purchaser pays a micropayment (i.e., <$1.00) are aggregated over time in a purchaser's computing device. Eventually accumulated transaction information is downloaded to a trusted payment authority for settlement. The trusted payment authority pays the merchant for all aggregated transactions in a single funds transfer. Transactions among many purchasers may also be aggregated into a single funds transfer. By aggregating micropayments within the purchaser's computing device, the amount of money involved in transactions processed through the payment authority can become large enough to justify the transactions costs of exchanging money between the purchaser and various merchants. The aspects enable business to economically charge and receive micropayment amounts.

### RELATED APPLICATIONS

This application claims the benefit of priority to U.S. Provisional Patent Application No. 61/529,012 entitled “METHODS AND SYSTEMS AGGREGATING MICROPAYMENTS IN A MOBILE DEVICE” filed Aug. 30, 2011, the entire contents of which are hereby incorporated by reference.

### FIELD OF THE INVENTION

The present invention relates generally to mobile electronic payment systems and more particularly to methods and systems for enabling economically viable processing of micropayments by aggregating payments on a mobile device for settlement.

### BACKGROUND

The potential business models for providers of web and/or digital content are currently limited by the constraints on processing online payments from users. The only widely deployed payment mechanisms are provided by banks and credit cards, which are generally economically worth processing only for amounts at least over $1.00. For example, the minimum transaction permitted in Apple's iTunes is 99 cents. This is due in large part to the high transaction costs to the content provider of processing conventional electronic transactions. This problem makes it very difficult for content providers to obtain a return on the costs to generate content that consumers are unlikely to pay more than a few cents to view or play. These per-transaction costs cannot be made up for even for extremely large volumes of transactions which might otherwise occur if users were charged in real-time for each content access (for example, each time they visit a webpage). For example, in April 2010 CNN.com had a total of 1,400,000,000 page views. An attempt to charge a couple pennies to each individual view (which people might be willing to pay) could cost CNN over a $100 million, even though the potential revenue at two cents per view would be $28 million. Also, this number of small transaction would lead to a massive burden in the back-end payment systems. Thus, content providers are often forced to either to provide their content for free and generate revenue solely from advertisements, or require a user to purchase a subscription to their content, for example, with a monthly fee. As a consequence, these providers lose out on revenues from potential users who would be willing to pay a small amount for a single access to content, but do not wish to pay for a subscription. This problem is not limited to on-line merchants, because many small businesses must pass on transaction costs to customers paying with credit cards for small purchases (e.g., a cup of coffee or tea).

### SUMMARY

The various aspects include system, devices and methods that enable cost-effective processing of micropayments using a computing device. An aspect method for accomplishing micropayment transactions between a purchaser's computing device and a merchant system may include initiating a transaction between the purchaser's computing device and the merchant system, transmitting mutual authentications between the mobile device and the merchant system, receiving in the purchaser's computing device transaction information from the merchant system, storing the received transaction information within secure memory of the purchaser's computing device, receiving a request for stored transaction information from a payment authority server, transmitting the stored transaction information to a payment authority server, and the payment processing server paying an aggregate amount to the merchant on behalf of the purchaser. In an aspect, the method may further include the payment authority server charging an account of the purchaser for an aggregate amount of stored transactions transmitted to the payment authority server.

In an aspect, the method may further include the payment authority server aggregating transaction information from a plurality of purchasers, in which the payment processing server paying an aggregate amount to the merchant on behalf of the purchaser includes aggregating transaction amounts from a plurality of purchasers, and paying the merchant an aggregate amount on behalf of the plurality of purchasers. In an aspect, the transaction information may include one or more of a transaction ID, a content provider, a date, a cryptographic hash or other mechanism to enable authentication of the transaction parties and the integrity of the transaction information, and a payment amount for the transaction. In an aspect, the method may further include transmitting a transaction acknowledgement message from the purchaser's computing device to the merchant system as part of completing a purchase transaction.

In an aspect, the method may further include transmitting mutual authentication information between the purchaser's computing device and the payment authority server, verifying the payment authority server in the purchaser's computing device, and verifying the purchaser's computing device in the payment authority server, in which the verification of the payment authority server and the purchaser's computing device are accomplished prior to transmitting the stored transaction information to the payment authority server. In a further aspect, receiving a request for stored transaction information from a payment authority server may include the payment authority server contacting the purchaser's computing device, the payment authority server and the purchaser's computing device negotiating a secure communication link, and the payment authority server transmitting the request for stored transaction information to the purchaser's computing device via the secure communication link.

In an aspect, the method may further include the purchaser's computing device determining that transaction data should be downloaded to the payment authority, the purchaser's computing device sending a message to the payment authority server requesting initiation of the session to download transaction data, the payment authority server and the purchaser's computing device negotiating a secure communication link, and the payment authority server transmitting the request for stored transaction information to the purchaser's computing device via the secure communication link. In an aspect, purchaser's computing device may determine that transaction data should be downloaded to the payment authority based upon one or more of a total amount of money in the stored transactions equals or exceeds a threshold value, the total number of stored transactions equals or exceeds a threshold value, an age of a stored transaction equals or exceeds a threshold value, a duration since a last downloaded transaction data equals or exceeds a threshold value, and amount of memory available for storing additional transaction data is less than or equal to a threshold value, a battery power level of the purchaser's computing device is less than or equal to a threshold value, a location of the purchaser's computing device, activation of an application configured to protect data stored in the purchaser's computing device in the event of loss or theft, and a user input.

In an aspect, storing the received transaction information within secure memory of the purchaser's computing device may include storing the received transaction information within a transaction store within a secure domain of the computing device. In an aspect, the method may further include negotiating a secure communication link between the payment authority server and the transaction store within the secure domain of the computing device processor prior to transmitting the stored transaction information to the payment authority server. In an aspect, initiating a transaction between the purchaser's computing device and the merchant system is accomplished by an application running within a non-secure portion of the purchaser's computing device processor.

In a further aspect a system for enabling micropayment electronic transactions may include a purchaser computing device, a payment authority server, and merchant server, in which the purchaser computing device includes a processor having a non-secure domain and a secure domain including secure memory, with the processor configured with processor-executable instructions to establish communication links with the payment authority server and the merchant server via one or more communication links and to perform operations of the aspect methods, the payment authority server is configured with server-executable instructions to establish communication links with the purchaser computing device via a communication link and to perform operations of the aspect methods, and the merchant server is configured with server-executable instructions to establish a communication link with the purchaser computing device and to perform operations of the aspect methods.

In a further aspect a system for enabling micropayment electronic transactions may include means for accomplishing the functions recited in one or more of the aspect methods.

In a further aspect a computing device may include a processor comprising a non-secure domain and a secure domain including secure memory, in which the processor is configured with processor executable instructions to perform operations of one or more of the aspect methods.

In a further aspect a computing device may include means for accomplishing the functions recited in of one or more of the aspect methods.

In a further aspect a non-transitory processor-readable storage medium may have stored thereon processor-executable instructions configured to cause a processor of a computing device to perform operations of one or more of the aspect methods.

In a further aspect a server may include a server processor configured with server-executable instructions to perform operations of one or more of the aspect methods.

In a further aspect a server may include means for accomplishing the server functions recited in of one or more of the aspect methods.

In a further aspect a non-transitory server-readable storage medium may have stored thereon server-executable instructions configured to cause a server to perform server operations of one or more of the aspect methods.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a diagram illustrating interactions between the three principal parties in a conventional electronic payment.

FIGS. 2A and 2B are diagrams illustrating interactions between the three principal parties in electronic payment transactions according to the various aspects.

FIG. 3 is a process flow diagram of a method for aggregating micropayment transactions within a computing device according to an aspect.

FIG. 4 is a process flow diagram of an aspect method for collecting aggregated micropayment transactions by a trusted payment authority according to an aspect.

FIG. 5 is a message flow diagram illustrating some of electronic transaction messages exchanged between the various components and participants in the aspect methods illustrated in FIGS. 3 and 4.

FIG. 6 is a process flow diagram of another aspect method for aggregating micropayment transactions and downloading them to a trusted payment authority.

FIG. 7 is a process flow diagram of an aspect method receiving aggregating micropayment transactions in any trusted payment authority.

FIG. 8 is a component block diagram of mobile computing device suitable for use with the various aspects.

FIG. 9 is a component block diagram of a personal computer (laptop computer) suitable for use in an aspect.

FIG. 10 is a component block diagram of a server device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “computing device” and “mobile device” refer to a variety of computer devices, including but not limited to cellular telephones, personal television devices, personal data assistants (PDAs), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, receivers within vehicles (e.g., automobiles), interactive game devices, notebooks, smartbooks, netbooks, tablets (e.g., Apple®, iPad®, Samsung®, Galaxy®), mobile television devices, wireless modem dongles, computers (e.g., laptop computers) coupled to a wireless modem, computers coupled to a dongle, or other portable programmable computing devices.

The various aspects provide an economic solution to the micropayment problem by enabling businesses (e.g., internet media content providers and small businesses) to receive payments for very small transactions (known and referred to herein as “micropayments”) from users without losing money on transaction costs by processing such payments in bulk instead of individually. Transactions in which a user is required to pay a micropayment (i.e., such as a few pennies for access to “premium” content) are aggregated over time in a purchaser's computing device, such as a smartphone. Eventually the accumulated micropayment transactions are downloaded to a trusted payment authority for settlement. By aggregating micropayments, the amount of transactions processed through the payment authority can become large enough to justify the transactions costs of exchanging money between the purchaser and various merchants. This approach makes it economically viable for business to charge and receive micropayment amounts. Additionally, the aspects reduce the total volume of electronic transactions between merchants and payment authorities, so that even while the number electronic transactions may increase as micropayments are enabled, the number of exchange transactions may remain manageable for the trusted payment authorities and merchants.

The various aspects may be useful in situations in which users of computing devices (e.g., smartphones) want to listen to an MP3 track, play a game on the Internet, or access premium content (e.g., the full length of a online magazine article) for which the content provider or merchant charges a micropayment amount (e.g., a penny per play or access). When the user makes an input to the mobile device to purchase such content, the corresponding micropayment is recorded in a secure memory of the computing device (e.g., smartphone) and the merchant is informed that payment will be rendered by the trusted payment authority. The merchant or content provider's computer system can validate the computing device to confirm that it can rely on the promise of payment so the transaction can be processed and the content delivered. The purchase authentication mechanisms enable the merchant to authenticate a purchaser (or at least the purchaser's computing device) without requiring a subscription or merchant-specific login.

Many mobile devices are equipped with processors that include a secure domain which includes secure storage and security mechanisms for confirming the authenticity of applications. A common approach on computing devices (e.g., mobile devices) without secure processors is to use a “Secure Element,” which, in addition to including tamper proof software and encrypted store may include tamper proof execution units. The most common embodiments are the UICC (or SIM card) and the Secure Element, which may be soldered to the computing device or embedded in a removable device (e.g. a chip and PIN credit card or an SD memory card). The various aspects leverage the mobile device processor secure portion or “trusted zone” to tally micropayments, acknowledge a micropayment to a merchant, and execute a payment transaction for aggregated amounts. The trusted zone contains the software and data that has been verified as being secure. Computing devices that do not include processors having a secure portion may accomplish the aspects through use of encrypted storage and verifiable, tamper proof software. In this manner, financial data processing and authentication between the device and third party servers can be protected from potential vulnerabilities (e.g., phishing attacks, hackers, etc.).

When a micropayment is to be made according to an aspect, the purchaser's computing device records transaction data in secure memory, such as the merchant or content provider, the micropayment amount (e.g., $0.01), and other useful transaction details (e.g., date, time, a description of the purchased item, a merchant transaction identifier, an authentication hash, etc.) Such payment tallies are stored in secure memory accessible only through the secure portion of the device processor to prevent the purchaser (or hackers) from tampering with the payment system. Payment tallies may be maintained for any number of separate merchants.

To collect a micropayment, a merchant's transaction system may inform the mobile device of the transaction details, typically including a merchant ID (so a transaction entity can know who to pay), a transaction ID (for record keeping purposes), and a transaction amount (e.g., $0.01). This information may be delivered over any communication network, such as the Internet, Bluetooth®, or a Near Field Communication (NFC) link such as are now installed in many points of purchase. In response, the mobile device may transmit a response to the merchant system over the same link indicating payment is made. This response may include data that the merchant can use to confirm that the transaction has been processed by the trust zone and thus is trustworthy, such as a hash of the transaction information provided by the merchant performed using a key only available to the trust zone.

For each purchase, the software on the purchaser's computing device may record in the secure memory the transaction ID, the merchant ID, the payment amount (e.g., a micropayment of $0.01), and optionally other data (e.g., date, time, GPS location, etc.) that is sufficient to identify the transaction. The payment amount may be tallied in a running total for the merchant. At a later date a trusted payment authority may communicate with the purchaser's computing device to retrieve the stored transaction information from several transactions. The trusted payment authority may then process all micropayments in one or a few transactions to a pay each merchant in a single, aggregate payment. The trusted payment authority may also aggregate the micropayment tallies of multiple users, so the number of payments to each merchant per unit time (e.g., monthly) is minimized to further reduce the overhead expense of electronic funds transfers.

In overview, the purchasing application within a purchaser's computing device (e.g., a smartphone or personal computer) may send a signal to initiating a purchase with a merchant computer system such as a server, via a communication link, such as the Internet via a cellular data network, or a NFC link at a point of purchase. The merchant server and a secure credentials store within the secured portion of the purchaser's computing device may perform mutual authentication of one another's credentials. For example, the credentials store may send a credential to the merchant server, and the merchant server sends a credential to the credentials store. This can be performed using standard cryptographic techniques and methods now used with NFC payment cards and tokens, and smart credit cards. In this manner, the merchant server can verify the identity of the purchaser, or at least the trustworthiness of the purchaser's computing device, and the purchaser's computing device can verify the identity of the merchant. In an aspect, the merchant server may assign a unique identifier for the transaction that is provided to the purchaser's computing device so that a purchaser only needs to be authenticated by the merchant system in the first interaction with the merchant system. Thereafter, the purchaser's computing system may simply send the unique identifier, or a hash of that identifier and the transaction amount, to enable the merchant system to trust the user and authorize completion of the transaction.

Once these authentications are accomplished, the user may be permitted to complete the purchase transaction. During the purchase transaction, the merchant server may send a message to a transaction store in the secure domain of the purchaser's computing device to record information about the purchase transaction. This information may be stored in a transaction store, such as in a data table structure. In an aspect, transaction information may include: the identity of the merchant, a transaction ID, the date, and the price for the content purchase that is now owed to the merchant. An acknowledgment message may be sent back to the merchant server to confirm that the purchase has been credited to the merchant (i.e., that a transaction has been stored listing that payment owed to that merchant). This completes the transaction, so the merchant may release the purchased goods or services (e.g., indicating to an employee that the user has paid for his coffee, or delivering content via the Internet). This payment process may be repeated each time the user makes a purchase, such as by requesting access to premium content on the merchant's website.

The following table illustrates an example of a transaction store for six user purchases.

| | | | Cost/Payment credit |
|---|---|---|---|
| Date | Transaction ID | Merchant | to Merchant |
| Jun. 1, 2011 | 0011 | iTunes | $0.15 |
| Jun. 5, 2011 | 0012 | New York Times | $0.12 |
| Jun. 7, 2011 | 0013 | New York Times | $0.02 |
| Jun. 7, 2011 | 0014 | iTunes | $0.15 |
| Jun. 7, 2011 | 0015 | iTunes | $0.15 |
| Jun. 7, 2011 | 0016 | iTunes | $0.15 |

The process of recording and tallying user purchase transactions according to the various aspects is repeated until a threshold has been met or a condition has been satisfied to cause a trusted payment authority to retrieve the transactions. The trusted payment authority provider can be, for example, a bank, a credit card company (e.g., Visa or MasterCard), or other financial processing entity (e.g., PayPal®). In an aspect, the trusted payment authority retrieves transactions after a predetermined period of time has passed, for example, once per month. In another aspect, the purchaser's computing device informs the trusted payment authority provider that transactions should be retrieved when the total purchase amount has reached a predetermined limit, for example, when the purchaser's purchases total $20.00. In a third aspect, the user may initiate the transaction retrieval, such as by bringing his/her mobile device within communication range of a terminal with NFC capabilities. In a fourth aspect, the purchaser's computing device activates the transaction download process in response to other conditions or events which may help to ensure the integrity of the payment system as described in more detail below. Other mechanisms for initiating retrieval of aggregated transactions may be implemented.

When the trusted payment authority is triggered to retrieve transactions, another mutual authentication takes place, this time between the credentials store in the purchaser's device and the trusted payment authority's server. This communication may be secure (i.e., encrypted) and accomplished via any communication network, such as a cellular data network coupled to the Internet. The trusted payment authority polls the transaction store of the purchaser's computing device to determine whether any transactions are stored, or alternatively whether any new transactions have been recorded since the last retrieval. If there are no transactions, or no new transactions, in the transaction store, the trusted payment authority may update a “Last Transactions Checked” field with the current date and terminate the secure communication link.

If the purchaser's computing device has any transactions stored, the trusted payment authority may access the secure area of the computing device or request the secure area of the device to download the stored data over a network interface. The trusted payment authority retrieves the information for each stored transaction (i.e., the Merchant, transaction ID, date, and amount). The trusted payment authority may debit the purchaser's account for the aggregate amount, such as charging the purchaser's credit card for the total of all micropayments stored in the device. Alternatively, the trusted payment authority may aggregate all of the purchaser's transactions into a single invoice, which can be paid by the user via any existing payment mechanism (e.g. PayPal®, credit card, mobile phone bill, etc.). The trusted payment authority determines the amount to be paid to each merchant from the aggregate of the micropayment amounts by the user. Using the example transaction store data table above, the purchaser would be invoiced or his/her credit card may be charged for $0.74, from which the trusted payment authority would distribute $0.14 to the New York Times, and $0.60 to iTunes. In this manner, the merchants receive one regular payment as opposed to repeatedly receiving micropayments. In a further aspect, the trusted payment authority may further aggregate payments from many users before transmitting a single large payment to the merchant. In this manner, the financial burden on the merchant of transaction costs may be further minimized.

In sum, the various aspects enable an efficient and cost-effective mechanism for accumulating micropayments using a secure memory of a purchaser's computing device under the control of secure software operating within a secure portion of the purchaser's computing device, such as under the control of the secure domain of a mobile device processor. In this manner, fewer transmissions and payment transactions are required to effectuate the micropayment transactions, because it is the aggregated transaction information that is transmitted to a payment processing server, and the payment processing system pays merchants based upon the aggregation of transaction from many users.

The limitations of current electronic payment mechanisms are due in large measure to the fact that electronic transactions suffer from a problem of anonymity afforded by electronic communications. Specifically, the two parties involved in a given transaction do not see or know each other; thus there is no opportunity for the personal trust and verification that has protected commerce transactions for thousands of years. Even though electronic transactions may be small, this anonymity problem can enable a nefarious party to receive goods without payment or steal money from unwitting parties. Also, the smaller the electronic transaction, the less likely the victim can afford to pursue the perpetrator. Thus, without a trust mechanism, electronic transactions would be practically infeasible. A number of trust mechanisms and payment solutions have been developed over the past several decades for enabling trusted electronic transactions. These mechanisms have enabled the rise of Internet commerce, rapidly process credit card transactions, and business-to-business money exchanges.

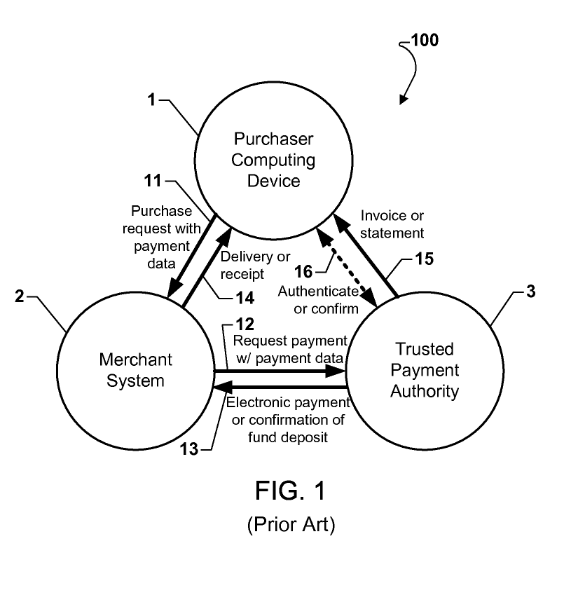

FIG. 1 illustrates a communication system 100 including the basic components and messages of classic mechanisms for enabling electronic transactions among the three principal parties in a typical consumer transaction, namely a purchaser 1, a merchant system 2, and a trusted payment authority 3. The trusted payment authority 3 may be any business or entity which enables the payment of money to merchants 2 on behalf of purchasers 1. The role of banks as trusted payment authorities in cashing checks is very old. In modern electronic commerce, a large number of businesses are involved and participating as such trusted payment authorities. Examples include credit card companies, Internet transaction collection businesses, and third party payment services (e.g., PayPal®), to name just a few. These businesses serve as the financial middleman between the purchaser and the merchant, making good on the purchaser's promise to pay the merchant a promised amount for the transaction. Therefore, the term “trusted payment authority” is used herein to refer to any and all business entities that may serve the role or perform some or all of the functions described herein for delivering payments to merchants on behalf of purchasers. For brevity, the term “bank” is used in the figures.

In traditional electronic commerce systems, the trust problem posed by the anonymous electronic transaction has been resolved by the establishment of trusted payment authorities 3 which are known and trusted by both the purchaser 1 and the merchant 2. Additionally, the use of encryption and encrypted hash functions using encryption keys provided by trusted third party verifiers (e.g., VeriSign, Inc.) or by the trusted payment authorities themselves has reduced the opportunities for fraud and abuse of the payment system. A variety of encrypted identifiers, hash function encryption keys and secure transaction processes have been deployed in the marketplace. To some extent, all trusted electronic payment processes follow the communication processes illustrated in FIG. 1.

In a typical electronic commerce transaction illustrated in FIG. 1, a purchaser using a computing device, such as a personal computer or smartphone, transmits a purchase request message 11, which may include payment data, such as the purchaser's credit card number and associated data in parentheses e.g., expiration date and additional security codes). The purchase request message 11 may be preceded by a large number of electronic messages between the purchaser computer system 1 and the merchant system to, such as viewing catalog items, receiving payment forms, ordering quantities, negotiating prices, etc. Upon receiving the purchase request message 11, the merchant system 2 may transmit a payment request message 12 to a trusted payment authority 3, such as the purchaser's credit card company. This payment request message 12 may include payment data such as the purchaser's credit card number and associated data, the purchase amount, the merchant's identifier, and other information that may be required as part of the electronic payment process implemented by the trusted payment authority 3. Using the received payment request message 12 and information stored in data records, the trusted payment authority 3 verify the purchaser and confirm that the producer's account is current or includes sufficient funds to support the transaction, in which case an electronic payment or confirmation message 13 may be transmitted to the merchant system 2. In many cases, this message 13 merely confirms that the merchant will be paid for the transaction and is in the form of an authorization message. At this point, the trusted payment authority has verified the purchaser on behalf of the merchant, giving the merchant confidence that payment will be received when the transaction is completed. The merchant system 2 may then proceed to complete the transaction by delivering the goods and providing a payment receipt 14 the purchaser's computing device 1. In the case of online purchases, such as music, videos, digital media, or software, the merchant system 2 may also deliver the purchased product in message 14. This purchaser credit verification process is familiar to anyone who has used a credit card to pay for goods in a store and waited for the credit card to be verified during checkout.

At some later time, the trusted payment authority may provide an invoice or statement 15 to the purchaser or the purchaser's computing device. An example is a credit card statement which the trusted payment authority 3 expects the purchaser to pay. The delivery of this statement may be accomplished through a paper check type of transaction or a different electronic transaction (not shown). In some cases the trusted payment authority 3 may also communicate with the purchaser's computing device 1 during the electronic transaction process in electronic message exchanges 16 in order to confirm the identity of the purchaser and/or enable the purchaser to confirm that the transaction is legitimate. At some later point, the trusted payment authority 3 will transfer funds to the merchant system 2, such as through traditional inter-bank fund transfer mechanisms (not shown).

While the well-established electronic payment transaction processes illustrated in FIG. 1 have proven to be very trustworthy and efficient, they necessarily involve transaction costs which limit their application to relatively large transactions. Each of the purchaser verification communications 12, 13, 16, and the processing and reply of the trusted payment authority 3 involve real costs and opportunity costs due to the necessary communication and computing infrastructure, the limited bandwidth of the secure communication links, and the costs associated with accomplishing banking transactions. As a result, there is a practical economic minimum transaction value for which traditional electronic payment mechanisms are suitable. For example, it is noted that the minimum price charged by Apple's iTunes service and Amazon.com is $0.99. If the value of the item being purchased is less than that, merchants either bundle the items into larger packages, such as monthly subscriptions, or give away their product for free and rely on other revenue-generating mechanisms, such as online advertising. This suggests that there may be significant markets for items of commerce that would be valued by purchasers at less than $0.99 which could be sold to generate additional if the transaction costs of collecting those funds can be substantially reduced.

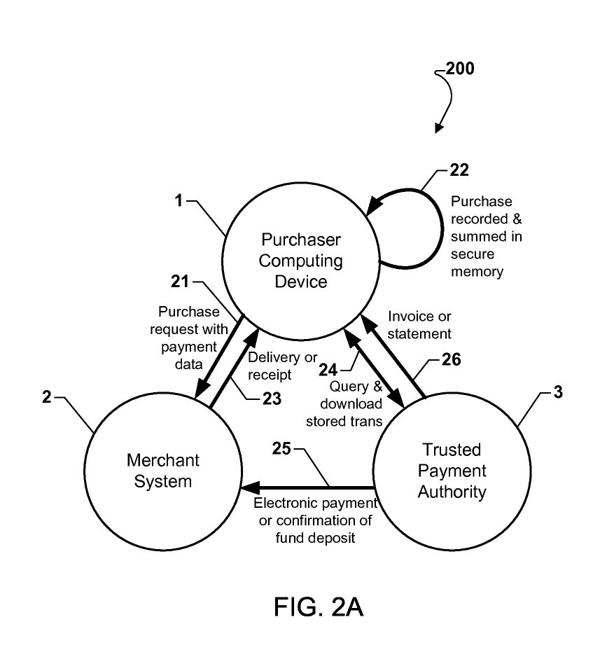

As discussed above, the various aspects overcome the limitations of the current electronic systems by enabling the purchaser's computing device 1 to aggregate a number of micropayment transactions so the total amount can reach a value large enough to justify the cost of the funds exchange between the trusted payment authority and the merchant system. The various aspects are illustrated in FIG. 2A, which shows a communication system 200 including the same three transaction participants, namely the purchaser computing device 1, merchant system 2, and trusted payment authority 3.

Electronic transaction may begin in a manner very similar to that of current transactions by the purchaser computing device 1 providing a purchase request with payment data in message 21. Similar to traditional electronic transactions as illustrated in FIG. 1, the purchase request and payment data message 21 may indicate the intent to purchase the item and provide payment data on which the merchant system 2 can rely. However, rather than providing a credit card or similar number to the merchant system for obtaining payment from the trusted payment authority 3, the purchase request and payment data message 21 includes a verifiable indication that the purchaser computing device 1 can be trusted to aggregate the micropayment and ensure that the merchant will be paid eventually. Thus, the purchase request and payment data message 21 may include information that enables the merchant system 2 to determine that the payment transaction can be trusted.

A variety of mechanisms can be used to enable the merchant system 2 to determine that the other computing device 1 can be trusted to complete the micropayment process. As discussed above, the various aspects may utilize a secure domain that is available within many computing device processors, particularly those used in smartphones. Since such secure domains cannot be accessed by unauthorized software, they are relatively secure from hacking or fraudulent manipulation. Thus, encrypted identifiers or trust credentials can be stored in a secure portion of memory (referred to herein as the “credential store”) that can only be accessed through verified and trusted communication links. The trust domain of the computing device processor may be controlled or verified by a third party trusted by merchants and payment authorities, which may be the processor manufacturer or a third-party which verifies the secure domains in processors assembled into computing devices. Since the merchant can rely on the secure domain of the computing device, and thus the credential provided in the purchase request and with payment data message 21, it is possible for the merchant system 2 to verify the purchaser without having to communicate with the trusted payment authority 3. While there is some risk associated with self authenticating purchasers, the small value of money involved in a micropayment means that the value at risk is relatively small, so the verification mechanism can make good commercial sense. Also, efforts to counterfeit credentials or defeat the secure domain and credential store of particular microprocessors can be detected by the trusted payment authority, which can periodically update the merchant system 2 in order to maintain the integrity of the overall system.

To provide further security, the information transmitted by the purchaser computing device 1 to the merchant system 2 may be in the form of encrypted or hashed values which cannot be counterfeited or replicated in a man-in-the-middle hacking scheme. For example, the confidential credential assigned to a processor secure domain may not be communicated in the purchase request and payment data message 21. Rather, the credential may be used in a secret algorithm that is applied to transaction data, including some transaction data that may be provided by the merchant system 2 (e.g., a unique transaction identifier) to generate an encrypted value or hash that is transmitted to the merchant system 2. The merchant system 2 may use another confidential algorithm to process the received hash value to obtain and confirm the transaction information known to the merchant system. This merchant algorithm may use decryption techniques that will reveal the transaction data only if the hash value was generated using a valid and trusted credential without requiring that the merchant system 2 knows the credential. Such encryption/decryption verification techniques are well known and can provide a high level of security. Again, while such techniques can theoretically be defeated, the small value of the involved transactions means that any risk to the merchant in any one transaction is financially very small. Also, the significant challenges and costs involved in counterfeiting or faking such encrypted verification mechanisms means that it is unlikely criminals would waste such efforts on micropayment transactions.

Since the merchant system 2 is able to determine that the transaction is being accomplished with a purchaser computing device having a verified secure domain and a valid credential, the merchant system 2 can proceed to complete the transaction, such as by delivering the product and/or a receipt in message 23, without the assistance of the trusted payment authority. The product deliver and/or receipt message 23 may include additional information from the merchant system 2 that will be included within stored aggregated payment data, such as to identify the merchant, identify the transaction, and/or specify limitations or requirements on payment. Thus at this point, the purchaser has received the purchase goods and the merchant system 2 is relying on the payment system for eventual payment. The merchant need not take further action, such as submitting transactions to a payment authority as is the case with checks and credit card transactions.

In the various aspects, information known to the purchaser computing device from one or both of the purchase request and payment data message 21 and the delivery and/or receipt message 23 may be recorded in a secure memory in operation 22. The secure memory may be within the secure domain of the computing device processor, such as in what is referred to herein as a “transaction store.” Being located within the trusted secure domain of the computing device processor, this transaction data is protected from access by various applications or hackers, and can only be accessed by a trusted payment authority 3 using a secure communication link through the processor secure domain as discussed below.

The process of accomplishing micro payment transactions with a variety of merchant systems 2 through purchase and receipt messages 21, 23, and the storage of the transaction data within a transaction store in operation 22 can be repeated many times, thereby aggregating a large number of micropayment transactions. Even though individual transactions may be for a few pennies, eventually the total amount of purchase transactions will sum to an amount that justifies the cost of completing the electronic transactions through a trusted payment authority 3.

At some point, such as when the stored transactions total to a predefined amount or at regular intervals (e.g., monthly), the purchaser computing device 1 and the trusted payment authority 3 may initiate a communication link to download the accumulated stored transaction data. This may be accomplished by one of the two systems contacting the other and the two systems exchanging verification information to enable negotiation of a secure communication link. Once a secure communication link is established, the stored transaction data may be downloaded from the transaction store to the trusted payment authority 3. These communications are illustrated in FIG. 2A as message exchange 24. Mechanisms for identifying computing devices to one another and negotiating secure communication links are well known and may be used to establish the message exchange 24. In this process, the trusted payment authority 3 may communicate directly with the processor secure domain of the purchaser's computing device 1, so the trusted payment authority 3 can rely on the received information as it is provided directly from the transaction store through a portion of the processor that is not accessible to other software or hacking.

The trusted payment authority 3 may complete the communication exchanges with the purchaser computing device 1 by providing an invoice or statement 26, which may be presented to the user. Also or alternatively, the invoice or statement 26 may be provided to the purchaser or through other channels, such as US mail. Also, the completed transaction information may be posted on a secure website hosted by the trusted payment authority 3 which the purchaser computing device 1 can access in order to download the transaction data (i.e., invoice or statement message 26 may be delivered in response to a request by the purchaser computing device 1).

Payment of the merchant may be accomplished periodically by the trusted payment authority 3, such as by electronic payment or deposit of funds in a merchant account illustrated by message 25. In order to further reduce the per transaction costs of the payment system, the trusted payment authority 3 may aggregate the payments due to each merchant from a large number of purchasers, so that only a single fund transfer operation is required to pay the merchant for a very large number of micropayment transactions. For example, the trusted payment authority 3 may pay the merchant monthly an amount of money corresponding to the aggregated transactions of a large number of purchasers. In this manner, the fixed costs associated with the final payment transaction 25 can be a small fraction of the total amount of money transferred. Thus, by aggregating transactions within purchaser computing devices 1 and again across multiple purchasers within the trusted payment authority 3, the aspects reduce the overhead associated with enabling micropayment transactions.

In the various aspects, the trusted payment authority 3 may have a variety of business relationships with the purchaser and the purchaser's computing device 1. In some aspects, the trusted payment authority 3 maybe a credit card company in which the trusted payment authority has a contract with the purchaser to pay amounts as indicated on monthly invoices. In other aspects, the trusted payment authority 3 may hold some amounts of money provided by the purchaser in advance, and deduct funds transferred to merchants from the purchaser's account balance. Settlement of the account between the purchaser and the trusted payment authority 3 may take place through electronic communications 26 or traditional paper invoices. Thus, at this point, the purchaser provides the aggregated transaction amounts to the trusted payment authority 3 so that all parties have received the funds for each micropayment purchase.

As the transaction messages illustrated in FIG. 2A suggest, the various aspects differ from the classic electronic payment methods in that the purchase initiation message 21 amounts to a promise to pay the merchant without providing the information that the merchant could use to obtain payment directly from the trusted payment authority 3. As discussed above, the merchant is able to rely on this promise to pay because it is able to verify that the message was provided by a secure domain of the purchaser's computing device 1.

FIG. 2B illustrates the components and message exchanges discussed above in more detail. As discussed above, a purchaser computing device 1 may include a processor having a non-secure portion 205 and a secure domain 210. The secure domain 210 may be included in a chipset formed during manufacture, or located in another software or hardware location. The non-secure portion of the processor 205 performs most of the control, processing and running of applications on the computing device 1. This may include running the purchasing application 215 which supports the purchaser in performing a transaction, such as by providing interfaces, displaying web pages, etc. The purchasing application 215 may communicate with the merchant system 2 through any of a variety of available communication links, such as a near field communication (NFC) transceiver 230 coupled to the non-secure domain of the processor 205, or a network connection 235 (e.g., a local area network transceiver, WiFi transceiver or cellular data network transceiver). The purchasing application 215 may also be able to receive information from the secure domain 210, such as credentials or hash values that the purchasing application can communicate to the merchant system 2 to enable verification. For example, the purchasing application 215 may provide transaction data (e.g., such as may be known to the purchasing application or received via transaction messages 11 and 14) to the processor secure domain for the generation of an encrypted credential or hash, which can be passed to the merchant system 2 by the purchasing application 215. In this aspect, the merchant system 2 does not have to be trusted to communicate directly with the processor secure domain, thereby providing greater protections against fraudulent manipulations of the transaction store by untrustworthy merchants. The processor secure domain 210 may be configured with processor-executable instructions to perform a variety of verification, encryption, and related transaction-securing processing of data and credentials to support and secure the payment mechanisms of the various aspects.

To download aggregated transactions, the trusted payment authority 3 can contact the purchaser computing device 1 and negotiate secure communication links directly with the processor secure domain 210. Such communication links may be through any of a variety of communication networks, such as local area network connections to the Internet, a WiFi network connected to the Internet, and/or a cellular data network connected to the Internet. In order to verify that the communication link is actually established with the intended transactions store 220, the trusted payment authority 3 may first verify the processor secure domain 210 by exchanging credentials (or hash transaction values based upon secure credentials) provided by the credential store 225 in a secure communication link 24a. In this manner, the trusted payment authority 3 can ensure that it has established a secure communication link 24b directly with the transaction store 220. Such communications may be supported by the non-secure portion of the processor 205; however, the encryption of the communication links may be accomplished so that data passing through the non-secure processor 205 is already encrypted. Thus, even if the purchaser computing device 1 is infected with nefarious software, such software is unable to access the processor secure domain 210, and thus is not able to intercept or influence the secure communication links 24a, 24b or access the information being exchanged.

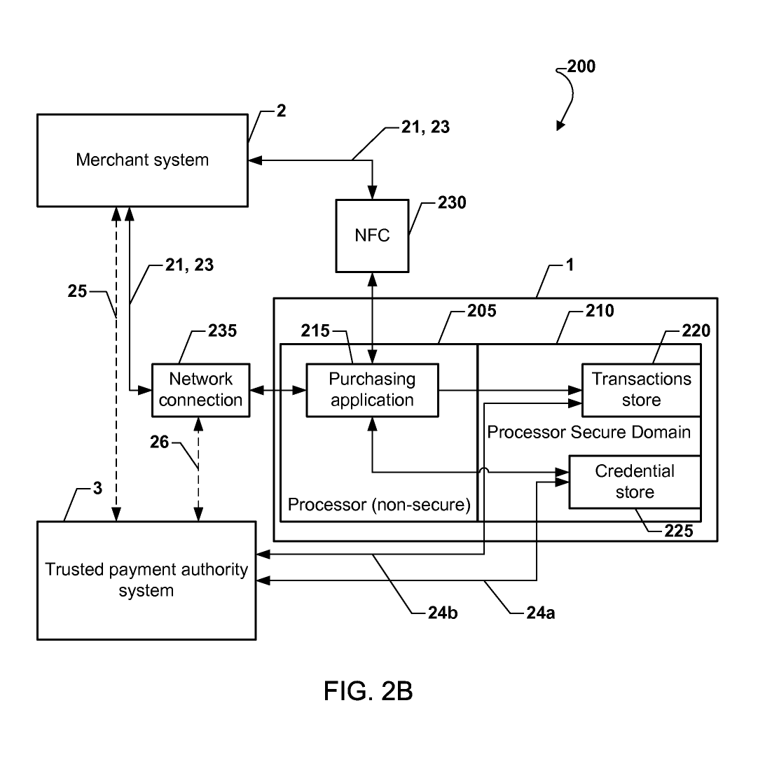

FIG. 3 illustrates an example method 300 for implementing the various aspects on a computing device. The method 300 may be implemented on a computing device by configuring it with processor executable instructions to perform the operations illustrated in the figure and described below. In method 300 at block 305, a user may use his or her computing device (e.g., a smartphone or personal computer) to initiate a payment or purchase transaction by interacting with the computing device user interface. For example, a user purchasing a cup of coffee may present the purchaser's smartphone to an NFC receiver at a point-of-purchase terminal to initiate a payment transaction. As another example, a user may access a shopping cart checkout webpage from an Internet transaction site and click on the check out icon to purchase an item (e.g., access to a newspaper article, access to a song, or downloading of a ring tone). In block 310, the purchaser's computing device may transmit a payment authorization and confirmation message to the merchant's system. As discussed above, this transmission may include information that authenticates the purchaser's computing device as one configured and registered for making micropayments according to the various aspects. As discussed above, this may include authentication and confirmation data that is unique to the secure domain of the purchaser's computing device or generated with such information to enable a merchant system to authenticate the purchaser's computer. The purchaser's computer system computing device may then await a reply from the merchant system. In block 315, the user purchaser computing device may receive a reply message from the merchant system providing transaction data and authentication credentials. As mentioned above, such authentication credentials and transaction data may allow the purchaser to confirm that the transaction is about to be made with the correct company. This may be presented to the purchaser so that the purchaser can confirm the transaction details. This step enables the user to guard against unauthorized parties generating unauthorized transactions in order to collect micropayments from the purchaser's computing device. This also may prevent man-in-the-middle attacks in which another party might attempt to hijack a transaction in order to receive payments intended for another merchant. The information received at block 315 may also include details which need to be stored in memory to record the micropayment transaction.

In block 320, the transaction data received from the merchant, and optionally information generated by the purchaser computing device, may be recorded in a secure memory of the computing device, such as a transaction store 220 within the processor secure domain 210. This transaction data storage may be in any accessible data format, such as a data table, an example of which is provided above.

The purchaser computing device may also monitor for query message contacts from the trusted payment authority (“bank” in FIG. 3). In the aspect illustrated in FIG. 3, the purchaser computing device awaits a contact from the trusted payment authority which will initiate a download of the store transactions. So long as the trusted payment authority does not contact the purchaser computing device 1, (i.e., determination block 325=“No”), the computing device may stand by for the next micropayment purchase transaction by returning the block 305.

When the purchaser computing device is contacted by the trusted payment authority (i.e., determination block 325=“Yes”), the computing device, and more particularly the secure domain of the 210 of the device processor, may negotiate a secure communication link with the trusted payment authority system in block 330. This negotiation of a secure data link may include negotiation of a secure data link followed by the exchange of authentication credentials between the computing device and the trusted payment authority. Such authentication information may enable the two computing systems to mutually confirm that they are indeed communicating with the intended system. Methods for negotiating secure communication links and for authenticating computing systems to one another are well known in the computer arts.

In block 335, the purchaser computing device may download transaction data from the secure data store (e.g., transactions store 220) to the trusted payment authority. Once all the transaction data has been downloaded, the purchaser computing device may clear transaction data in the secure memory in block 340. Erasing the transaction data from secure memory enables the purchaser's computing device to continue recording transactions without requiring a large secure memory. Optionally, in block 345, the purchaser computing device may receive and display a payment record statement or invoice received from the trusted payment authority.

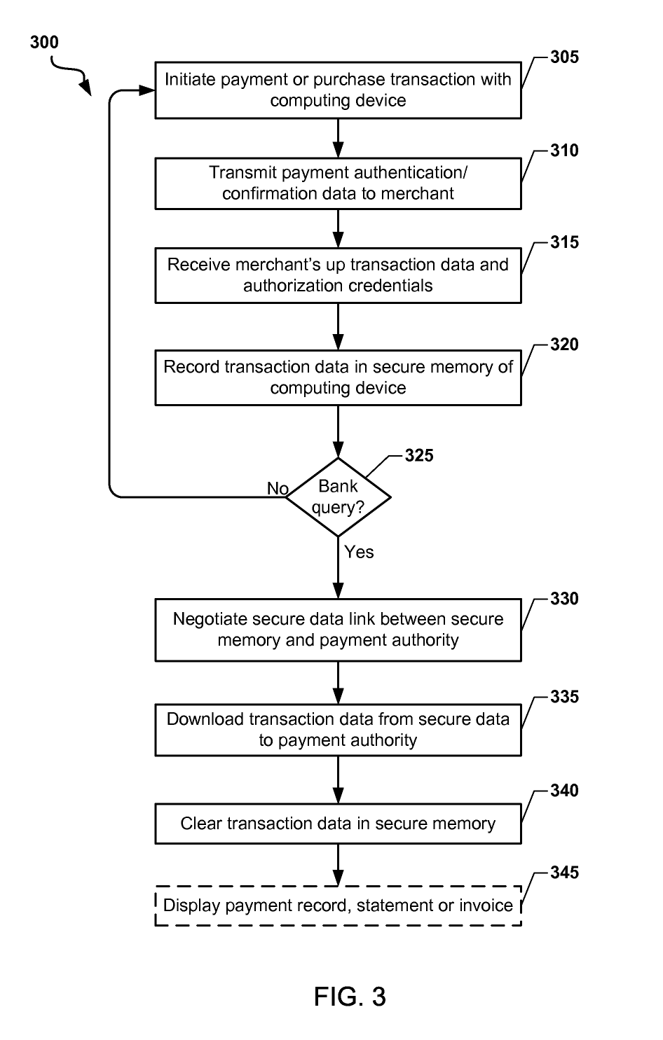

An example method 400 that may be implemented in the computing system (e.g., a server or system of servers) of a trusted payment authority is illustrated in FIG. 4. Method 400 may be implemented by configuring a server with executable instructions configured to perform the method operations. In method 400 in block 405, the trusted payment authority server may select a particular purchaser or subscriber for polling and downloading of transaction data. In block 410, the server may access database records for the selected subscriber or purchaser in order to obtain contact information (e.g., an e-mail address, telephone number, URL, etc.), purchaser-specific authentication and confirmation data (e.g., a purchaser identifier, unique credential data, and/or encryption/decryption keys), and other information required to contact the purchaser computing device, authenticate the purchaser computing device, and authenticate itself to the computing device. In block 415, the trusted payment authority server may send an initial query message to the selected purchaser computing device. The type and form of message transmitted in block 415 will depend upon the type of computing device and its network connection. For example, if the purchaser computing device is a smartphone, the query message may be in the form of an SMS message or e-mail message which prompts the smartphone to reply to a particular URL. In block 420, the server may negotiate a secure communication data link with the purchaser computing device, and in particular with the secure portion of the computing device processor 210.

Once the secure communication link is established, in block 425 the server may request and receive authentication information from the purchaser's computing device, such as credentials or hashed values generated using an encryption key maintained in the credential store 225. Using the received information, the server may authenticate the computing device processor secure domain 210 using any well known computer authentication technique. If the server confirms that the secure communication link is established with the correct secure memory, in block 430, it may request a download of the stored transaction data, and store the received transaction records in the purchaser's account.

Optionally, in block 435, the server may transmit a summary or statement of the received transactions to the purchaser computing device before terminating the secure communication link. Alternatively or in addition, in block 440, the server may generate and send an invoice or statement to the purchaser reflecting the transactions that have been received and any payments to or a balance in the purchaser's account with the trusted payment authority. In an example implementation, this statement may be very similar to a conventional credit card statement that the user is expected to pay.

In determination block 445, the server may determine whether there are other purchasers or users to be polled, and if so (i.e., determination block 445=“Yes”), return to block 405 to select the next purchaser or subscriber for polling.

Once all purchasers have been polled and their transaction data recorded (i.e., determination block 445=“No”), the server may determine the aggregate amounts that are owed to each merchant on behalf of all users in block 450. This may involve sequentially accessing the various purchaser accounts and adding the recorded transaction amounts to the corresponding merchant accounts. In an aspect, the process of determining aggregate merchant balances may be accomplished as part of the process of receiving transaction records, and not as part of a separate operation. Finally, the trusted payment authority server may accomplish the fund transfers and generate the necessary checks to pay each merchant the aggregate amount that they are due on behalf of all users in block 455.

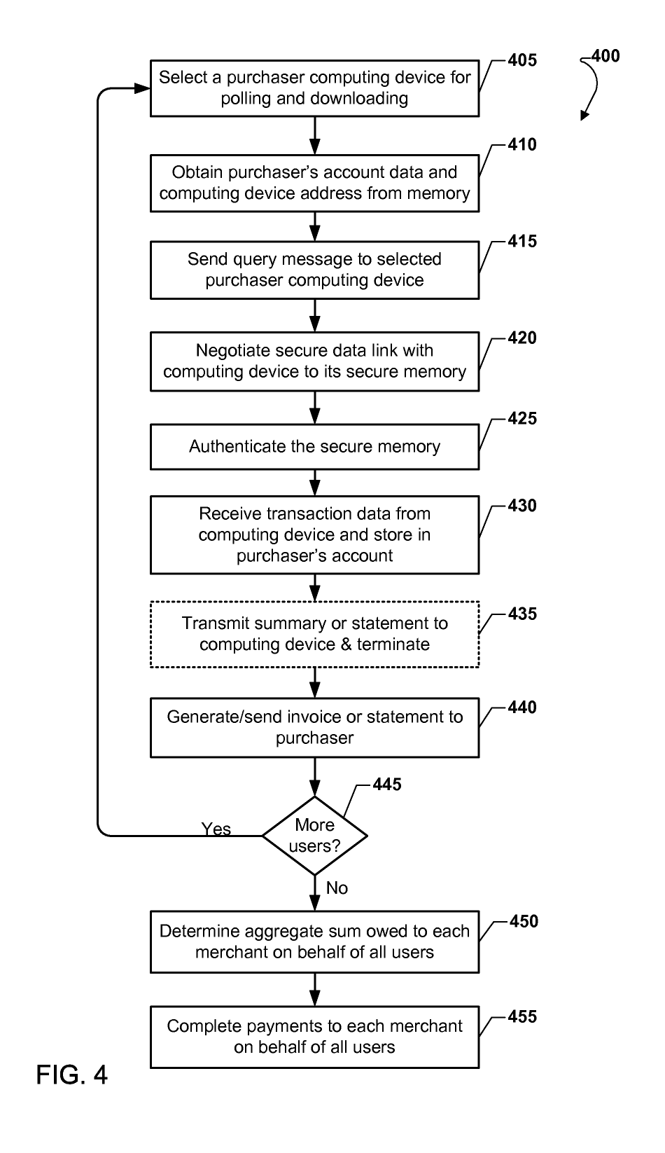

An illustration of example messages may be exchanged in the various aspects is shown in the message flow diagram that is FIG. 5. This figure illustrates some of the messages involved in accomplishing the transactions described above. As discussed above, a user 1 may interact with his or her computing device to initiate a payment transaction, which is illustrated as user input 500. This input may be processed by a payment application 215 operating within the purchaser's computing device, which may transmit a message 505 to the merchant system 2 to initiate the mutual authentication of the computing device and the merchant purchase system. Message 505 may include initiation of a secure communication link or an NFC communication link which is sufficiently secure due to its very short range. In operations 510, the merchant system 2 and the secure portion 210 of the purchaser's computing device processor may authenticate each other. This mutual authentication may be accomplished between the merchant system and the credential store 225. Such authentication may involve a series of messages 510 in which the merchant system 2 provides authentication and credential information to the purchaser's computing device sufficient to enable the credential store 225 to authenticate the merchant. Once the merchant system has been authenticated, the credential store 225 may similarly transmit to the merchant system 2 authentication information in message 515 sufficient to enable the merchant system to authenticate the credential store 225. The exchange of mutual authentication information and operations 510 may be exchanged over the secure communication link or NFC communication link.

Once the merchant and purchaser computing device have been mutually authenticated, the operations 520 to store the transaction data in the transaction store 220 may be accomplished. This may involve the merchant system 2 transmitting transaction details in message 525 directly to the transaction store 220 through the secure communication link. The transaction store 220 may also transmit an acknowledgment message 530 back to the merchant system 2. This transaction detail message may include a unique value, such as a hash of the transaction details that the merchant system can later use to determine when a payment for the particular transaction has been received. For example, this information may be included in a statement associated with a payment from the trusted payment authority. Thus, through the exchange of messages 525 and 530, the merchant system 2 and the transaction store 220 exchange and store information sufficient for the transaction to be later completed with proper accounting and balancing of accounts.

FIG. 5 also illustrates messages which may be exchanged between the trusted payment authority 3 and the purchaser's computing device transaction store 220 during download of transaction data. After mutually authenticating the transaction store 220 and the trusted payment authority server 3, the trusted payment authority may send a message 535 to the computing device transaction store 220 to inquire whether there are any stored transactions. The transaction store 220 may respond with a transaction store results message 540. If there are transactions stored in the transaction store 220 (i.e., transaction store results=true), transaction download operations 550 may commence. This may involve the trusted payment authority server 3 sending a fetch transactions message 555 to the transaction store 220. In response to such a message, the transaction store 220 may initiate a download of the stored transaction data in transmissions 560. Once all of the transaction data have been received, the trusted payment authority server 3 may send a message 565 informing the transaction store that the last transactions have been checked. If there are no transaction stored in the transaction store 220 (i.e., transaction store results=false), the trusted payment authority server may send a message 570 informing the transaction store that the last transactions have been checked. In response to receiving such a message, the transaction store 220 may clear all of the stored data to make room for further transactions. In an aspect, a date of the downloading or query may be stored in the transaction.

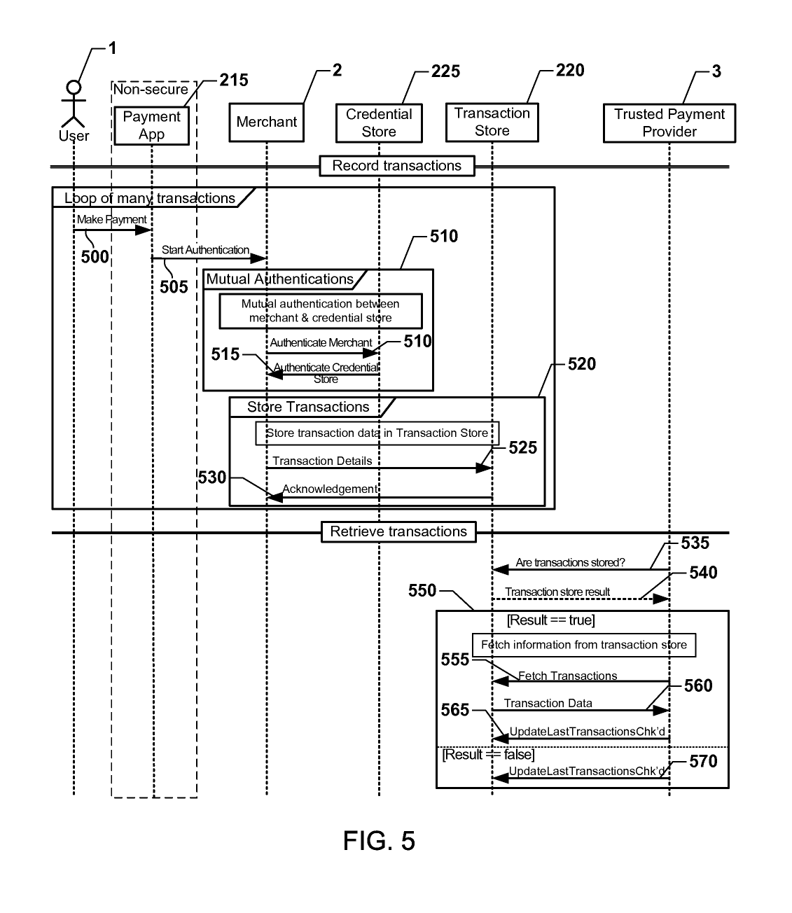

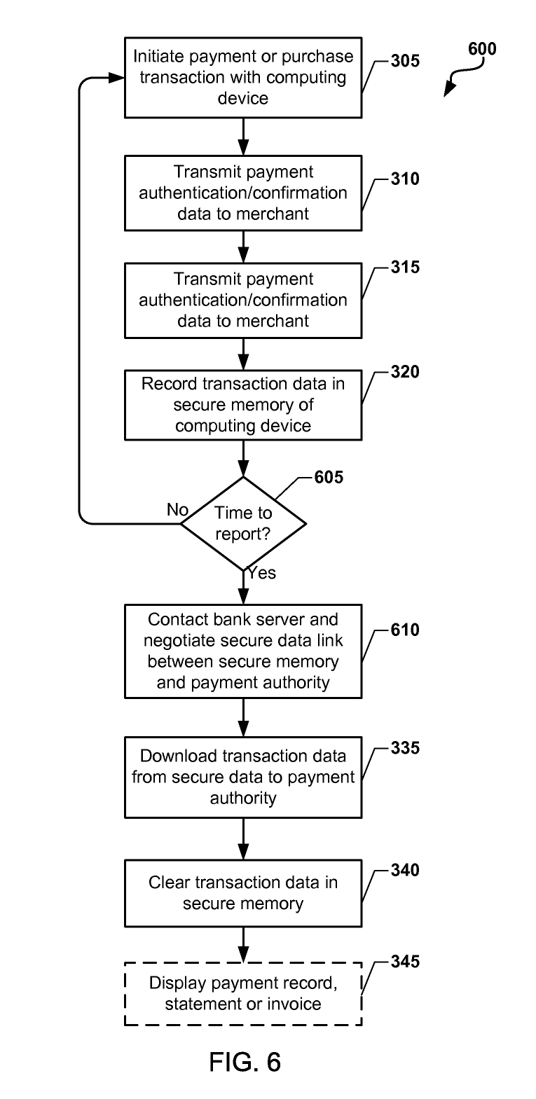

In another aspect, the purchaser's computing device can be configured to contact the trusted payment authority when it determines that the stored transaction data should be downloaded. In an aspect, this determination may be made when the stored transactions aggregate to an amount that equals or exceeds a predefined threshold which is sufficient to economically justify the expense of downloading stored transactions. In this aspect, the computing device's processor secure domain is configured with processor-executable instructions to total the amount money pledged in micropayment transactions stored in secure memory, and to compare the total to a threshold value. In an aspect, the determination to initiate the download of transaction data may be based upon a number of other factors, some examples of which are described below. If the purchaser's computing device determines that stored transaction data should be downloaded, the computing device contacts the trusted payment authority server by an available communication network (e.g., LAN-to-Internet, WiFi-to-Internet, or cellular data network), and initiates the negotiation of a secure data communication link. This aspect is illustrated in FIG. 6 which shows operations of method 600 that may be accomplished in the purchaser's computing device, and in FIG. 7 which shows operations of method 700 which may be accomplished in a trusted payment authority server.

Turning to FIG. 6, method 600 is similar to method 300 in the conduct of individual transactions as illustrated in like numbered blocks. In determination block 605, however, rather than (or in addition to) waiting to be contacted by the trusted payment authority, the computing device's processor secure domain determines whether it is time to contact the trusted payment authority to download transaction data. As mentioned above, this determination may be made by totaling amounts of all transactions within the transaction stored and comparing that sum to a predetermined threshold value. Alternatively or in addition, the determination may be based on a number of transactions accomplished since the last download, an amount of time (e.g., days or weeks) since the last download was accomplished, and/or an age of the oldest stored transaction. For example, the purchaser computing device may be configured to report its stored transactions to the trusted payment authority when the number of transactions is large, even though the total amount may be small, in order to ensure merchants receive payments within a reasonable amount of time of purchases. Triggering the download of transactions based on the time since the last download was accomplished can provide a backup for the radio scheduled polling by the trusted payment authority, such as to address the case that the purchaser's computing device was turned off at the time it was polled. Triggering the downloading of transaction data based on the age of the oldest transaction can enable balancing the cost savings achieved through transaction aggregation against the need for merchants to close out transactions within a reasonable period of time for accounting purposes. Thus, transaction data downloads for infrequent purchasers may be delayed until either the amounts justify the costs of the message exchanges or practical business considerations require closing out transactions, even if they must be accomplished at a loss.

In another aspect, the computing device may initiate the download of transactions in situations where the address by which the computing device can be addressed (e.g. IP address) can change. Due to a general shortage of IP addresses in the commonly used ‘IPV4’ scheme, it is very usual for the address used to contact a given computing device to change. In view of this, the trusted payment authority may not, in many cases, have an efficient mechanism to poll the user's computing device. Using SMS to poll the computing device is one solution to this problem, but it may be undesirable since SMS message will cost the trusted payment authority some money. So, to enable the system to work when the user's computing device does not have a static IP address and to avoid the costs of polling the device via other communication channels, computing devices may be configured to initiate the communication link to the payment authority server via the Internet (or other network).

Determination block 605 may also be based upon operational factors of war known to the purchaser's computing device, such as memory status, battery status, and current operating conditions. For example, a download of transaction data may be initiated when an amount of memory remaining in the secure domain transaction store reaches a predefined minimum. This aspect enables the computing device to download transactions and clear the memory in order to make room for more transactions. As another example, a download of transaction data may be initiated when the battery of a mobile computing device reaches a predefined minimum. This aspect may ensure that transactions are recorded and merchants paid in case the mobile device has been lost or intentionally allowed to run down the battery. The determination to initiate a download operation in determination block 605 may be configured to run in the background so it runs even if the mobile device is in a low-power, battery-conserving state. As another example, in the case of a mobile computing device, a download of transaction data may be initiated when a mobile computing device begins “roaming” by communicating with another cellular telephone network or an internal GPS receiver indicates that the computing device is a large distance from the purchaser's home. This example enables transactions to be closed out when the purchaser is on travel or vacation.

In a further aspect, the determination to initiate a transaction data download session in determination block 605 may be initiated as part of, or in response to, a mobile device security application. For example, if the purchaser's mobile device is configured with an application that detects and takes certain cautionary actions when it has been stolen by monitoring location data, access code entries or incoming messages (e.g., an SMS), the activation of transaction downloads (i.e., determination block 605=“Yes”) may be initiated as part of sequences designed to protect the purchaser's information and/or report the location of the mobile device.

In a further aspect, the user may initiate a transaction data download session, such as by selecting an option to do so in a menu interface. In another aspect, the user may set a variety of conditions or thresholds to control when transaction downloads will occur. In another aspect, the control over when transaction downloads occur may be under the control of the trusted payment authority, and the user may have limited options for affecting when downloads occur.

So long as the purchaser's computing device does not determine that it is time to initiate a transaction download session (i.e., determination block 605=“No”), the device may continue to conduct micropayment transactions by returning to block 305. When the purchaser's computing device determines that it is time to download transaction data (i.e., determination block 605=“Yes”), the computing device contacts the server of the trusted payment authority (“bank” in the figure) and initiates the negotiation of a secure data communication link in block 610. This may be accomplished, for example, by the computing device sending a request to a URL of the trusted payment authority server using TCP/IP protocols via the Internet to open a secure communication session (e.g., SSL). As part of block 610, the computing device may identify itself and/or the purchaser to the trusted payment authority, such as by sending a user ID, a device ID (e.g., a MAC ID), an account number, and/or a pass code or hash value indicating that the communication is most likely legitimate. As discussed above with reference to FIG. 4, the purchaser's computing device and the trusted payment authority may negotiate the secure communication link between the device's processor secure domain and the server. Also as part of block 610, the server may identify and validate the purchaser's computing device secure domain, and vice versa, through the mutual exchange of credentials and/or encrypted hash values. Once the secure communication link is established and the authentication processes completed, the downloading of data may proceed as described above with reference to FIG. 3 through blocks 335-345.

Operations within the trusted payment authority server in this aspect are illustrated method 700 shown in FIG. 7. In this aspect, instead of or in addition to contacting purchaser computing devices, the server may receive a request from a purchaser computing device to establish a secure communication link in block 705. This communication may include a pass code or other credential that the server can use to preliminarily recognize the contact as legitimate, and unlikely to be an attack or an attempt to hack into the system. As discussed above, this request message may include information sufficient to identify the purchaser and/or the purchaser's computing device. Using this information, the server may look up the purchaser and/or the purchaser's computing device in a database in block 710 in order to obtain the account, authentication and communication information necessary to authenticate the purchaser/computing device and negotiate a secure communication link to the device's secure domain. Using the information obtained from an account database, the server may proceed to complete the downloading of data from the purchaser's computing device as described above with reference to FIG. 4 through blocks 425-455.

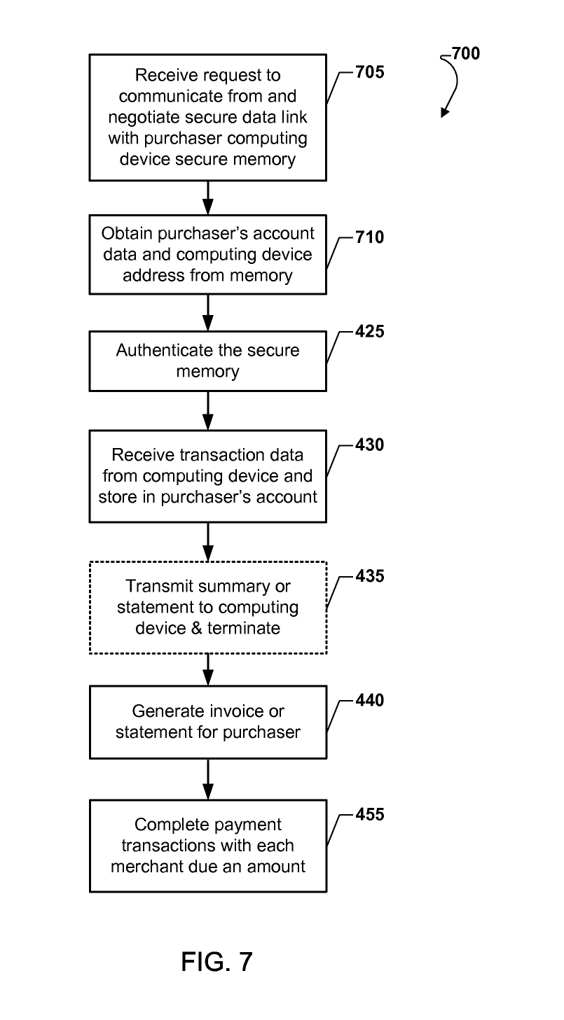

The various aspects may be implemented in a variety of mobile computing devices. An example of a mobile computing device that may implement the various aspects is a smartphone 800 illustrated in FIG. 8. A mobile computing device, such as a smartphone 800, may include a processor 801 coupled to memory 802 and to a radio frequency data modem 805. The mobile computing device processor 801 may be any programmable microprocessor, microcomputer or multiple processor chip or chips that can be configured by software instructions (applications) to perform a variety of functions, including the functions of the various aspects described herein. The radio frequency modem 805 may be coupled to an antenna 804 for receiving and transmitting radio frequency signal, such as cellular telephone signals and/or WiFi signals. The smartphone 800 may also include an NFC transceiver 812 for sending and receiving data over a short range NFC communication link, such as with a merchant's point-of-purchase terminal. The smartphone 800 may also include a display 803 (e.g., a touchscreen display) and buttons 806 to receive user inputs, such as to initiate a purchase transaction.

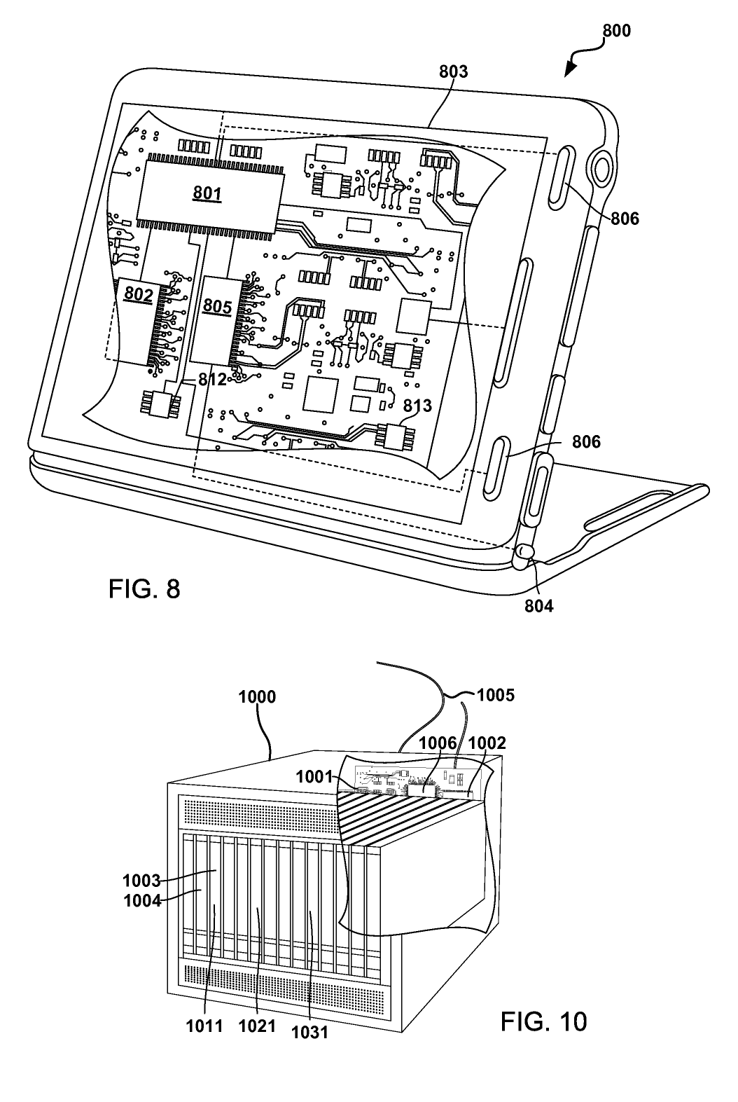

The various aspects may also be implemented on a variety of personal computing devices, such as a laptop computer 900 illustrated in FIG. 9. A laptop computer may include a programmable processor 901 coupled to internal memory 902. The processor 901 may also be coupled to the nonvolatile memory 903, such as a hard disk drive. Additionally, wireless communication modems 904 (e.g., a cellular data transceiver and/or WiFi transceiver) may be coupled to the processor 901, as well as network interface circuitry 905 which may enable coupling the computing device 900 to an external network, including the Internet. A personal computer will also include user interface devices, such as a pointer and mouse key assembly 907, keyboard 908 and display 909.

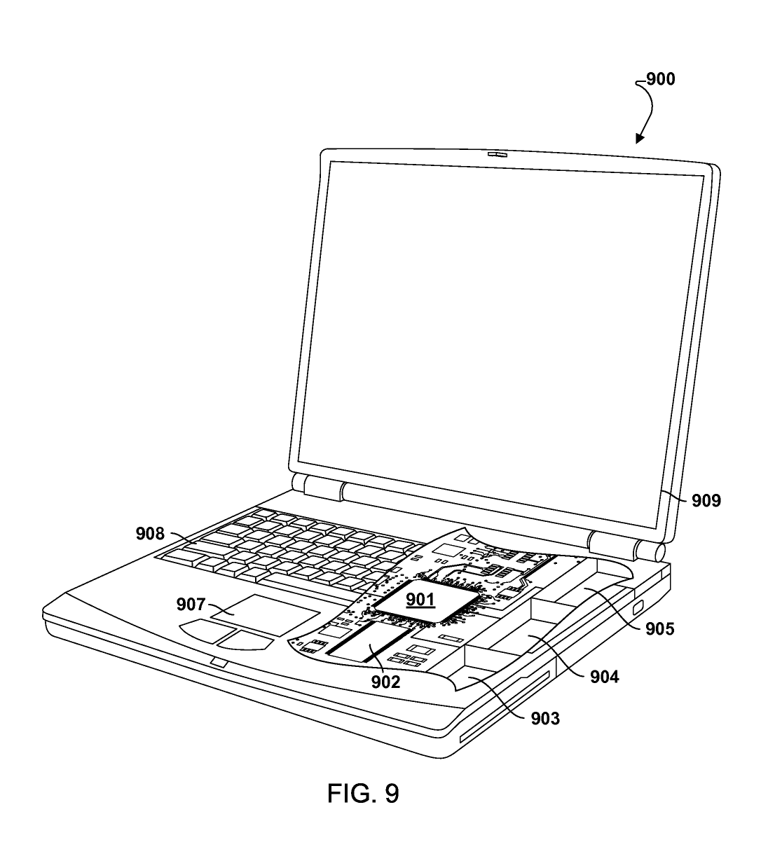

The various aspects may be implemented on the server side by any of a variety of commercial servers, an example of which is illustrated in FIG. 10. A server 1000 may include one or more server processors 1001 which are coupled to volatile memory 1002 as well as large capacity nonvolatile memory configured to maintain databases, such as disk drives 1003 and 1004. The server may also include network interface circuitry 1006 which enabled the server 1002 communicate with external networks 1005, such as the Internet. In a server installation, there may be several servers 1011, 1021, 1031 which may work together as a unit and/or in backup one to another.

The processors 801, 901, 1001 may be any programmable microprocessor, microcomputer or multiple processor chip or chips that can be configured by software instructions (applications) to perform a variety of functions, including the functions of the various aspects described above. In some devices, multiple processors 801, 901, 1001 may be provided, such as one processor dedicated to communication functions and one processor dedicated to running other applications.

Typically, software applications may be stored in the internal memory 802, 902, 903, 1002, 1003 before they may be accessed and loaded into the processor 801, 901, 1001. The internal memory 802, 902, 1002 may be a volatile or nonvolatile memory, such as flash memory, or a mixture of both. For the purposes of this description, a general reference to memory refers to all memory accessible by the processor 801, 901, 1001, including internal memory 802, removable memory plugged into the computing device, and memory within the processor 801, 901, 1001.

The foregoing method descriptions and the process flow diagrams are provided merely as illustrative examples and are not intended to require or imply that the operations or steps of the various aspects must be performed in the order presented. As will be appreciated by one of skill in the art the order of blocks in the foregoing aspects may be performed in any order. Words such as “thereafter,” “then,” “next,” etc. are not intended to limit the order of the operations or steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The aspect methods described herein may be implemented in a computing device by configuring a processor of the computing device with processor-executable instructions to perform the operations of the method. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the operations and functions described may be implemented in hardware, software, firmware, or any combination thereof. If implemented in software, the functions may be stored on or transmitted over as one or more instructions or code on a computer-readable medium. The operations of a method or algorithm disclosed herein may be embodied in a processor-executable software module which may be stored on a non-transitory computer-readable medium or processor-readable medium. Non-transitory computer-readable and processor-readable media may be any available storage media that may be accessed by a computer or processor. By way of example, and not limitation, such non-transitory computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A method of accomplishing micropayment transactions in a payment system comprising a purchaser's computing device comprising a secure memory, a merchant server, and a payment authority server, the method comprising:
initiating a transaction between the purchaser's computing device and the merchant server;
transmitting mutual authentications between the purchaser's computing device and the merchant server;
receiving in the purchaser's computing device transaction information from the merchant system;
storing the received transaction information within the secure memory of the purchaser's computing device;
receiving a request for stored transaction information from a payment authority server;
transmitting the stored transaction information to the payment authority server; and
paying an aggregate amount from the payment authority server to a merchant associated with the merchant server on behalf of a purchaser associated with the purchaser's computing device.

2. The method of claim 1, further comprising the payment authority server charging an account associated with the purchaser for the aggregate amount of stored transactions transmitted by the payment authority server.

3. The method of claim 1, further comprising the payment authority server aggregating transaction information from a plurality of purchasers,
wherein the payment authority server paying the aggregate amount to the merchant associated with the merchant server on behalf of the purchaser associated with the purchaser's computing device comprises:
totaling transaction amounts from the plurality of purchasers; and
paying the merchant the totaled amount on behalf of the plurality of purchasers.

4. The method of claim 1, wherein the transaction information comprises at least one of a transaction ID, a content provider, a date, a cryptographic hash, and a payment amount for the transaction.

5. The method of claim 1, further comprising transmitting a transaction acknowledgement message from the purchaser's computing device to the merchant system as part of completing a purchase transaction.

6. The method of claim 1, further comprising:
transmitting mutual authentication information between the purchaser's computing device and the payment authority server;
verifying the payment authority server in the purchaser's computing device; and
verifying the purchaser's computing device in the payment authority server,
wherein the verification of the payment authority server and the purchaser's computing device are accomplished prior to transmitting the stored transaction information to the payment authority server.

7. The method of claim 1, wherein receiving a request for stored transaction information from a payment authority server comprises:
negotiating a secure communication link between the purchaser's computing device and the payment authority server; and
receiving the request for stored transaction information at the purchaser's computing device from the payment authority server via the secure communication link.

8. The method of claim 1, wherein receiving a request for stored transaction information from a payment authority server comprises:
determining that transaction data should be downloaded from the purchaser's computing device to the payment authority server;
sending a message from the purchaser's computing device to the payment authority server requesting initiation of a session to download transaction data;
negotiating a secure communication link between the purchaser's computing device and the payment authority server; and
receiving the request for stored transaction information at the purchaser's computing device from the payment authority server via the secure communication link.

9. The method of claim 8, wherein the purchaser's computing device determines that transaction data should be downloaded to the payment authority based upon at least one of:
a total amount of money in the stored transactions equals or exceeds a threshold value;
a total number of stored transactions equals or exceeds a threshold value;
an age of a stored transaction equals or exceeds a threshold value;
a duration since a last downloaded transaction data equals or exceeds a threshold value;
an amount of memory available for storing additional transaction data is less than or equal to a threshold value;
a battery power level of the purchaser's computing device is less than or equal to a threshold value;
a location of the purchaser's computing device;
activation of an application configured to protect data stored in the purchaser's computing device in the event of loss or theft; and
a user input.

10. The method of claim 1, wherein storing the received transaction information within the secure memory of the purchaser's computing device comprises storing the received transaction information within a transaction store within a secure domain of the purchaser's computing device.

11. The method of claim 10, further comprising negotiating a secure communication link between the payment authority server and the transaction store within the secure domain of the purchaser's computing device processor prior to transmitting the stored transaction information to the payment authority server.

12. The method of claim 10, wherein initiating a transaction between the purchaser's computing device and the merchant system is accomplished by an application running within a non-secure portion of the purchaser's computing device processor.

13. A system for enabling micropayment electronic transactions, comprising:
a purchaser computing device;
a payment authority server; and
a merchant server,
wherein:
the purchaser computing device comprises a processor having a non-secure domain and a secure domain including secure memory, the processor configured with processor-executable instructions to establish communication links with the payment authority server and the merchant server via one or more communication links and to perform operations comprising:
initiating a transaction with the merchant server;
exchanging mutual authentications with the merchant server;
receiving transaction information from the merchant server;
storing the received transaction information within the secure memory;
receiving a request for stored transaction information from the payment authority server; and
transmitting the stored transaction information to a payment authority server;
the payment authority server is configured with server-executable instructions to establish communication links with the purchaser computing device via a communication link and to perform operations comprising:
transmitting a request for stored transaction information to the purchaser computing device;
receiving the stored transaction information from the purchaser computing device; and
paying an aggregate amount to a merchant associated with the merchant server; and
the merchant server is configured with server-executable instructions to establish a communication link with the purchaser computing device and to perform operations comprising:
exchanging mutual authentications with the purchaser computing device; and
transmitting to the purchaser computing device transaction information.

14. The system of claim 13, wherein the payment authority server is configured with server-executable instructions to perform operations further comprising aggregating transaction information from a plurality of purchasers,
wherein paying the aggregate amount to a merchant associated with the merchant server comprises:
aggregating transaction amounts from the plurality of purchasers; and
paying the merchant the aggregate amount on behalf of the plurality of purchasers.

15. The system of claim 13, wherein the payment authority server is configured with server-executable instructions to perform operations such that transmitting a request for stored transaction information to the purchaser computing device comprises:
contacting the purchaser computing device;
negotiating a secure communication link with the purchaser computing device; and
transmitting the request for stored transaction information to the purchaser computing device via the secure communication link.

16. The system of claim 13, wherein the purchaser computing device processor is configured with processor-executable instructions to perform operations such that receiving a request for stored transaction information from a payment authority server comprises:
determining that transaction data should be downloaded to the payment authority server;
sending a message to the payment authority server requesting initiation of a session to download transaction data;
negotiating a secure communication link with the purchaser computing device; and
receiving the request for stored transaction information via the secure communication link.

17. A system for enabling micropayment electronic transactions, comprising:
a purchaser computing device;
a payment authority server; and
a merchant server,
means for initiating a transaction between the purchaser computing device and the merchant server;
means for exchanging mutual authentications between the purchaser computing device and the merchant server;
means for receiving transaction information from the merchant server in the purchaser computing device;
means for storing the received transaction information within a secure memory of the purchaser computing device;
means for transmitting a request for stored transaction information to the purchaser computing device;
means for receiving a request for stored transaction information in the purchaser computing device from the payment authority server;
means for transmitting the stored transaction information from the purchaser computing device to the payment authority server; and
means for paying an aggregate amount to a merchant associated with the merchant server.

18. The system of claim 17, further comprising means for aggregating transaction information from a plurality of purchasers in the payment authority server,
wherein means for paying the aggregate amount to the merchant associated with the merchant server comprises:
means for totaling transaction amounts from the plurality of purchasers; and
means for paying the merchant the totaled amount on behalf of the plurality of purchasers.

19. The system of claim 17, wherein means for transmitting a request for stored transaction information to the purchaser comprise computing device comprises:
means for negotiating a secure communication link between the payment authority server and the purchaser computing device; and
means for transmitting the request for stored transaction information from the payment authority server to the purchaser computing device via the secure communication link.

20. The system of claim 17, wherein means for receiving a request for stored transaction information in the purchaser computing device from the payment authority server comprises:
means for determining that transaction data should be downloaded to the payment authority server;
means for sending a message from the purchaser computing device to the payment authority server requesting initiation of a session to download transaction data;
means for negotiating a secure communication link between the payment authority server and the purchaser computing device; and
means for receiving the request for stored transaction information in the purchaser computing device via the secure communication link.

21. A computing device, comprising:
a secure memory; and
a processor comprising a non-secure domain and a secure domain coupled to the secure memory, wherein the processor is configured with processor executable instructions to perform operations comprising:
initiating a transaction with a merchant server;
exchanging mutual authentications with the merchant server;
receiving transaction information from the merchant server;
storing the received transaction information within the secure memory;
receiving a request for stored transaction information from a payment authority server; and
transmitting the stored transaction information to the payment authority server.

22. The computing device of claim 21, wherein the transaction information comprises at least one of a transaction ID, a content provider, a date, a cryptographic hash, and a payment amount for the transaction.

23. The computing device of claim 21, wherein the processor is configured with processor executable instructions to perform operations further comprising:
transmitting a transaction acknowledgement message to the merchant server as part of completing a purchase transaction.

24. The computing device of claim 21, wherein the processor is configured with processor executable instructions to perform operations further comprising:
exchanging mutual authentication information with the payment authority server; and
verifying the payment authority server,
wherein the verification of the payment authority server is accomplished prior to transmitting the stored transaction information to the payment authority server.

25. The computing device of claim 21, wherein the processor is configured with processor executable instructions to perform operations further comprising:
determining that transaction data should be downloaded to the payment authority;
sending a message to the payment authority server requesting initiation of a session to download transaction data;
negotiating a secure communication link with the payment authority server; and
receiving the request for stored transaction information via the secure communication link.

26. The computing device of claim 25, wherein the processor is configured with processor executable instructions to perform operations such that determining that transaction data should be downloaded to the payment authority is based on based upon at least one of:
a total amount of money in the stored transactions equals or exceeds a threshold value;
a total number of stored transactions equals or exceeds a threshold value;
an age of a stored transaction equals or exceeds a threshold value;
a duration since a last downloaded transaction data equals or exceeds a threshold value;
an amount of memory available for storing additional transaction data is less than or equal to a threshold value;
a battery power level of the computing device is less than or equal to a threshold value;
a location of the computing device;
activation of an application configured to protect data stored in the computing device in the event of loss or theft; and
a user input.

27. The computing device of claim 21, wherein the secure domain of the computing device comprises a transaction store, and wherein the processor is configured with processor executable instructions to perform operations such that storing the received transaction information within the secure memory comprises storing the received transaction information within the transaction store.

28. The computing device of claim 27, wherein the processor is configured with processor executable instructions to perform operations further comprising negotiating a secure communication link with the payment authority server and the secure domain prior to transmitting the stored transaction information to the payment authority server.

29. The computing device of claim 27, wherein the processor is configured with processor executable instructions to perform operations such that initiating a transaction with the merchant server is accomplished by an application running within a non-secure portion of the processor.

30. A computing device, comprising:
means for initiating a transaction with a merchant server;
means for exchanging mutual authentications with the merchant server;
means for receiving transaction information from the merchant server;
means for storing the received transaction information within a secure memory;
means for receiving a request for stored transaction information from a payment authority server; and
means for transmitting the stored transaction information to the payment authority server.

31. The computing device of claim 30, wherein the transaction information comprises at least one of a transaction ID, a content provider, a date, a cryptographic hash, and a payment amount for the transaction.

32. The computing device of claim 30, further comprising means for transmitting a transaction acknowledgement message to the merchant server as part of completing a purchase transaction.

33. The computing device of claim 30, further comprising:
means for exchanging mutual authentication information with the payment authority server; and
means for verifying the payment authority server,
wherein the verification of the payment authority server is accomplished prior to transmitting the stored transaction information to the payment authority server.

34. The computing device of claim 30, further comprising:
means for determining that transaction data should be downloaded to the payment authority;
means for sending a message to the payment authority server requesting initiation of a session to download transaction data;
means for negotiating a secure communication link with the payment authority server; and
means for receiving the request for stored transaction information via the secure communication link.

35. The computing device of claim 34, wherein means for determining that transaction data should be downloaded to the payment authority comprise means for determining that transaction data should be downloaded to the payment authority based on at least one of:
a total amount of money in the stored transactions equals or exceeds a threshold value;
a total number of stored transactions equals or exceeds a threshold value;
an age of a stored transaction equals or exceeds a threshold value;
a duration since a last downloaded transaction data equals or exceeds a threshold value;
an amount of memory available for storing additional transaction data is less than or equal to a threshold value;
a battery power level of the computing device is less than or equal to a threshold value;
a location of the computing device;
activation of an application configured to protect data stored in the computing device in the event of loss or theft; and
a user input.

36. The computing device of claim 30, wherein means for storing the received transaction information within a secure memory comprises means for storing the received transaction information within a transaction store within a secure domain of the computing device.

37. The computing device of claim 36, further comprising means for negotiating a secure communication link with the payment authority server and the secure domain prior to transmitting the stored transaction information to the payment authority server.

38. The computing device of claim 36, wherein means for initiating a transaction with the merchant server comprises initiating a transaction with the merchant server by an application running within a non-secure portion of the computing device.

39. A non-transitory processor-readable storage medium having stored thereon processor-executable instructions configured to cause a processor of a computing device to perform operations comprising:
initiating a transaction with a merchant server;
exchanging mutual authentications with the merchant server;
receiving transaction information from the merchant server;
storing the received transaction information within a secure memory;
receiving a request for stored transaction information from a payment authority server; and
transmitting the stored transaction information to the payment authority server.

40. The non-transitory processor-readable storage medium of claim 39, wherein the transaction information comprises at least one of a transaction ID, a content provider, a date, a cryptographic hash, and a payment amount for the transaction.

41. The non-transitory processor-readable storage medium of claim 39, wherein the stored processor executable instructions are configured to cause a processor of a computing device to perform operations further comprising transmitting a transaction acknowledgement message to the merchant server as part of completing a purchase transaction.

42. The non-transitory processor-readable storage medium of claim 39, wherein the stored processor executable instructions are configured to cause a processor of a computing device to perform operations further comprising:
exchanging mutual authentication information with the payment authority server; and
verifying the payment authority server,
wherein the verification of the payment authority server is accomplished prior to transmitting the stored transaction information to the payment authority server.

43. The non-transitory processor-readable storage medium of claim 39, wherein the stored processor executable instructions are configured to cause a processor of a computing device to perform operations further comprising:
determining that transaction data should be downloaded to the payment authority server;
sending a message to the payment authority server requesting initiation of a session to download transaction data;
negotiating a secure communication link with the payment authority server; and
receiving the request for stored transaction information via the secure communication link.

44. The non-transitory processor-readable storage medium of claim 43, wherein the stored processor executable instructions are configured to cause a processor of a computing device to perform operations such that determining that transaction data should be downloaded to the payment authority is based on at least one of:
a total amount of money in the stored transactions equals or exceeds a threshold value;
a total number of stored transactions equals or exceeds a threshold value;
an age of a stored transaction equals or exceeds a threshold value;
a duration since a last downloaded transaction data equals or exceeds a threshold value;
an amount of memory available for storing additional transaction data is less than or equal to a threshold value;
a battery power level of the computing device is less than or equal to a threshold value;
a location of the computing device;
activation of an application configured to protect data stored in the computing device in the event of loss or theft; and
a user input.

45. The non-transitory processor-readable storage medium of claim 39, wherein the stored processor executable instructions are configured to cause a processor of a computing device to perform operations such that storing the received transaction information within a secure memory comprises storing the received transaction information within a transaction store within a secure domain of the computing device.

46. The non-transitory processor-readable storage medium of claim 45, wherein the stored processor executable instructions are configured to cause a processor of a computing device to perform operations further comprising negotiating a secure communication link with the payment authority server and the secure domain prior to transmitting the stored transaction information to the payment authority server.

47. The non-transitory processor-readable storage medium of claim 45, wherein the stored processor executable instructions are configured to cause a processor of a computing device to perform operations such that initiating a transaction with a merchant server is accomplished by an application running within a non-secure portion of the processor.

48. A server, comprising:
a server processor configured with server-executable instructions to perform operations comprising:
transmitting a request for stored transaction information to a purchaser computing device;
receiving the stored transaction information from the purchaser computing device; and
paying an aggregate amount to a merchant associated with a merchant server.

49. The server of claim 48, wherein the server processor is configured with server-executable instructions to perform operations further comprising aggregating transaction information from a plurality of purchasers,
wherein paying the aggregate amount to the merchant associated with the merchant server comprises:
totaling transaction amounts from the plurality of purchasers; and
paying the merchant the totaled amount on behalf of the plurality of purchasers.

50. The server of claim 48, wherein the server processor is configured with server-executable instructions to perform operations such that transmitting a request for stored transaction information to the purchaser computing device comprises:
contacting the purchaser computing device;
negotiating a secure communication link with the purchaser computing device; and
transmitting the request for stored transaction information to the purchaser computing device via the secure communication link.

51. A server, comprising:
means for transmitting a request for stored transaction information to a purchaser computing device;
means for receiving the stored transaction information from the purchaser computing device; and
means for paying an aggregate amount to a merchant associated with a merchant server.

52. The server of claim 51, further comprising means for aggregating transaction information from a plurality of purchasers,
wherein means for paying the aggregate amount to the merchant associated with the merchant server comprises:
means for totaling transaction amounts from the plurality of purchasers; and
means for paying the merchant the totaled amount on behalf of the plurality of purchasers.

53. The server of claim 51, wherein means for transmitting a request for stored transaction information to the purchaser computing device comprise:
means for contacting the purchaser computing device;
means for negotiating a secure communication link with the purchaser computing device; and
means for transmitting the request for stored transaction information to the purchaser computing device via the secure communication link.

54. A non-transitory server-readable storage medium having stored thereon server-executable instructions configured to cause a server to perform server operations comprising:
transmitting a request for stored transaction information to a purchaser computing device;
receiving the stored transaction information from the purchaser computing device; and
paying an aggregate amount to a merchant associated with a merchant server.

55. The non-transitory server-readable storage medium of claim 54, wherein the stored server-executable instructions are configured to cause a server to perform operations further comprising aggregating transaction information from a plurality of purchasers,
wherein paying an aggregate amount to the merchant associated with the merchant server comprises:
totaling transaction amounts from the plurality of purchasers; and
paying the merchant the totaled amount on behalf of the plurality of purchasers.

56. The non-transitory server-readable storage medium of claim 54, wherein the stored server-executable instructions are configured to cause a server to perform operations such that transmitting a request for stored transaction information to the purchaser computing device comprise:
contacting the purchaser computing device;
negotiating a secure communication link with the purchaser computing device; and
transmitting the request for stored transaction information to the purchaser computing device via the secure communication link.

57. A method of accomplishing a micropayment transaction between a computing device and a merchant server, comprising:
initiating, by the computing device, a transaction with a merchant server;
exchanging mutual authentications with the merchant server;
receiving, in the computing device, transaction information from the merchant server;
storing the received transaction information within a secure memory of the computing device;
receiving, in the computing device, a request for stored transaction information from a payment authority server; and
transmitting the stored transaction information from the computing device to the payment authority server.

58. The method of claim 57, wherein the transaction information comprises at least one of a transaction ID, a content provider, a date, a cryptographic hash, and a payment amount for the transaction.

59. The method of claim 57, further comprising completing transmitting a transaction acknowledgement message to the merchant server as part of completing a purchase transaction.

60. The method of claim 57, further comprising:
exchanging mutual authentication information with the payment authority server; and
verifying, in the computing device, the payment authority server,
wherein verifying the payment authority server is accomplished prior to transmitting the stored transaction information to the payment authority server.

61. The method of claim 57, further comprising:
determining, in the computing device, that transaction data should be downloaded to the payment authority;
sending a message from the computing device to the payment authority server requesting initiation of a session to download transaction data;
negotiating a secure communication link with the payment authority server; and
receiving, in the computing device, the request for stored transaction information via the secure communication link.

62. The method of claim 61, wherein determining, in the computing device, that transaction data should be downloaded to the payment authority comprises determining that transaction data should be downloaded to the payment authority based upon at least one of:
a total amount of money in the stored transactions equals or exceeds a threshold value;
a total number of stored transactions equals or exceeds a threshold value;
an age of a stored transaction equals or exceeds a threshold value;
a duration since a last downloaded transaction data equals or exceeds a threshold value;
an amount of memory available for storing additional transaction data is less than or equal to a threshold value;
a battery power level of the computing device is less than or equal to a threshold value;
a location of the computing device;
activation of an application configured to protect data stored in the computing device in the event of loss or theft; and
a user input.

63. The method of claim 57, wherein storing the received transaction information within the secure memory of the computing device comprises storing the received transaction information within a transaction store within a secure domain of the computing device.

64. The method of claim 63, further comprising negotiating a secure communication link with the payment authority server and the secure domain prior to transmitting the stored transaction information from the computing device to the payment authority server.

65. The method of claim 63, wherein initiating, by the computing device, a transaction with the merchant server comprises initiating a transaction with the merchant server by an application running within a non-secure portion of the computing device.
